(19) United States
(12) Patent Application Publication
(10) Pub. No.: US 2009/0048004 A1
(43) Pub. Date: Feb. 19, 2009

(54) INFORMATION PROCESSING APPARATUS

(75) Inventor: Kazuya Fukushima, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/055,177

(22) Filed: Mar. 25, 2008

(30) Foreign Application Priority Data
Aug. 17, 2007 (JP) 2007-213150

(51) Int. Cl. H04B 1/38

(52) U.S. Cl. 455/574

(57) ABSTRACT

An information processing apparatus includes: an antenna; a first wireless communication module that establishes wireless communication using a first communication system through the antenna; a second wireless communication module that establishes wireless communication using a second communication system through the antenna, the second communication system having a narrower communication range and smaller power consumption than the first communication system; a determination unit that determines whether or not wireless communication by the first wireless communication module or by the second wireless communication module is available; and a controller that controls the second wireless communication module to establish wireless communication using the second communication system regardless of whether or not wireless communication using the first communication system is established by the first wireless communication module when the determination unit determines that wireless communication by the second wireless communication module is available.

### CROSS-REFERENCE TO RELATED APPLICATIONS

This application is based upon and claims the benefit of priority from Japanese Patent Application No. 2007-213150, filed on Aug. 17, 2007, the entire content of which are incorporated herein by reference.

### BACKGROUND

1. Field

One embodiment of the invention relates to an information processing apparatus that is capable in power consumption reduction of a wireless communication module installed therein.

2. Description of the Related Art

In recent years, advancement of wireless communication technology has made possible for a user to connect to the Internet from the place where the user has gone with a wireless communication module installed in a mobile telephone or a computer.

Various systems of wireless communications are available and differ in communication frequency band, power consumption required for communications, and communication range. Therefore, it is desirable that communications should be established by properly using the communication system in response to the use environment. A document JP-A-2004-023768 (counterpart U.S. publication is: US 2004/014474 A1) discloses a mobile terminal capable of detecting the service area of each of 3G covering a wide area and WLAN of high-speed communications and switching the service.

The user is informed that the mobile terminal is in the area where local high-speed communication service, such as hot spot service, is provided, and duplicate use of both communication systems is prevented. Since the terminal is informed through a base station of the WLAN system that the terminal is within an access point service area of the WLAN system, the need for performing a search using a WLAN communication unit of the terminal at all times is eliminated and an increase in power consumption of the mobile terminal is prevented.

However, in the above-described system, wireless communications are switched simply in response to the place where the terminal exists and therefore it cannot necessarily be said that optimum control is performed for power saving.

### SUMMARY

According to a first aspect of the present invention, there is provided an information processing apparatus including: a housing; an antenna that is provided in the housing; a first wireless communication module that is provided in the housing and establishes wireless communication using a first communication system through the antenna; a second wireless communication module that is provided in the housing and establishes wireless communication using a second communication system through the antenna, the second communication system having a narrower communication range and smaller power consumption than the first communication system; a determination unit that determines whether or not wireless communication by the first wireless communication module or by the second wireless communication module is available; and a controller that controls the second wireless communication module to establish wireless communication using the second communication system regardless of whether or not wireless communication using the first communication system is established by the first wireless communication module when the determination unit determines that wireless communication by the second wireless communication module is available.

According to a second aspect of the present invention, there is provided an information processing apparatus including: a housing; an antenna that is provided in the housing; a first wireless communication module that is provided in the housing and establishes wireless communication using a first communication system through the antenna; a second wireless communication module that is provided in the housing and establishes wireless communication using a second communication system through the antenna, the second communication system having a narrower communication range and smaller power consumption than the first communication system; a third wireless communication module that is provided in the housing and establishes wireless communication using a third communication system through the antenna, the third communication system having a narrower communication range and smaller power consumption than the first communication system; a monitor circuit that monitors whether or not wireless communications by any one of the first through the third wireless communication module is available; and a controller that controls one of the second wireless communication module and the third wireless communication module to establish wireless communication using the second communication system or the third communication system regardless of whether or not wireless communication using the first communication system is established by the first wireless communication module when the determination unit determines that wireless communication by one of the second wireless communication module and the third wireless communication module is available.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a perspective view to show an appearance of a computer according to an embodiment of the present invention.

FIG. 2 is a block diagram to show a configuration of the computer according to the embodiment.

FIG. 3 is a block diagram to show a configuration of a wireless communication module according to the embodiment.

FIG. 4 is a drawing to show an example of the values of the communication ranges, the communication speeds, and the power consumptions of a 3G module, a WiMAX module, and a WLAN module according to the embodiment.

FIG. 5 is a flowchart to show the operation of wireless communication processing according to the embodiment.

FIG. 6 is a drawing to schematically show the communication ranges of the wireless communication modules according to the embodiment.

FIG. 7 is a drawing to schematically show a setting screen of the wireless communication modules according to the embodiment.

### DETAILED DESCRIPTION

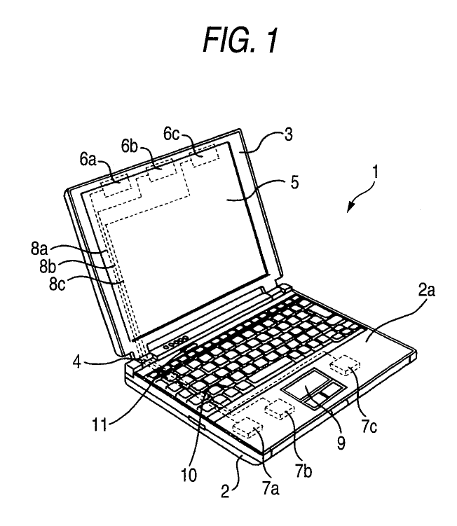

Referring now to the accompanying drawings, there is shown an embodiment of the present invention. In the description of the embodiment, as an information processing apparatus, a notebook computer 1 is taken as an example. FIG. 1 is a perspective view to show the appearance of the computer according to the embodiment.

The computer 1 includes a main unit 2 to which a display unit 3 is attached so that it can be pivoted through hinge parts 4. The display unit 3 can be pivoted between an opened position at which a top face 2a of the main unit 2 is opened and a closed position at which the top face 2a of the main unit 2 is closed. A display implemented as an LCD (Liquid Crystal Display) 5 is built in the display unit 3. A first antenna 6a, a second antenna 6b, and a third antenna 6c for establishing wireless communications are accommodated in the display unit 3. A circuit board installing electronic components is accommodated in the main unit 2 and a plurality of wireless communication modules 7 are installed in the circuit board. The first antenna 6a is a transmission-reception antenna used by a first wireless communication module 7a, and is configured so that the resonance frequency band of the first antenna 6a contains the frequency band for the first wireless communication module 7a (for example, 800 MHz to 2.2 GHz). The first wireless communication module 7a is connected to the first antenna 6a through a cable 8a. The cable 8a is derived into the display unit 3 from the main unit 2 through an opening made in the hinge part 4.

The second antenna 6b is a transmission-reception antenna used by a second wireless communication module 7b, and the second wireless communication module 7b is connected to the second antenna 6b through a cable 8b. The second antenna 6b is configured so that the resonance frequency band of the second antenna 6b contains the frequency band of the second wireless communication module 7b.

The third antenna 6c is a transmission-reception antenna used by a third wireless communication module 7c, and the third wireless communication module 7c is connected to the third antenna 6c through a cable 8c. The third antenna 6c is configured so that the resonance frequency band of the third antenna 6c contains the frequency band of the third wireless communication module 7c.

Similar to the cable 8a, the cables 8b and 8c are derived into the display unit 3 from the main unit 2 through an opening made in the hinge part 4. A touch pad 9 and a keyboard 10 are attached to the top face 2a of the main unit 2 and a power switch 11 for turning on/off power of the computer 1 is also provided.

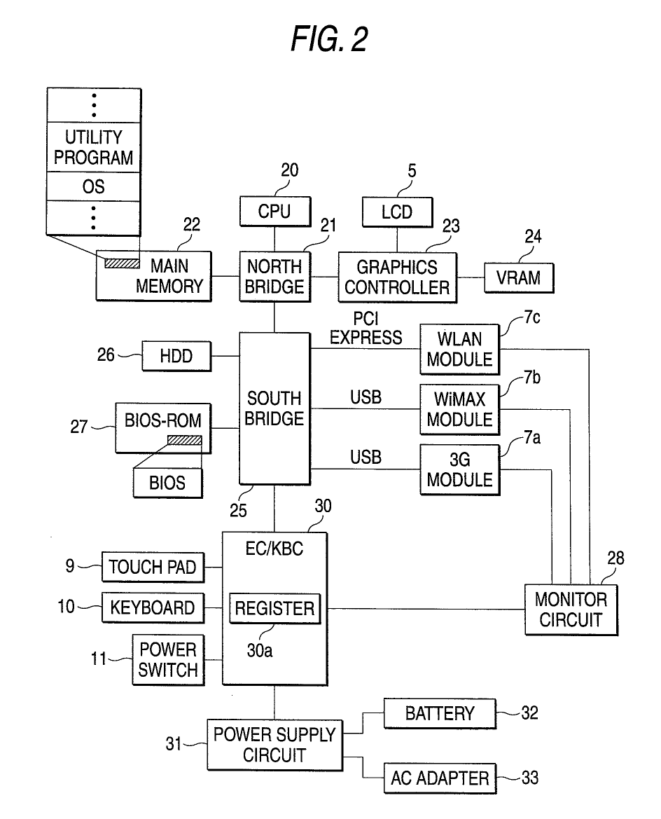

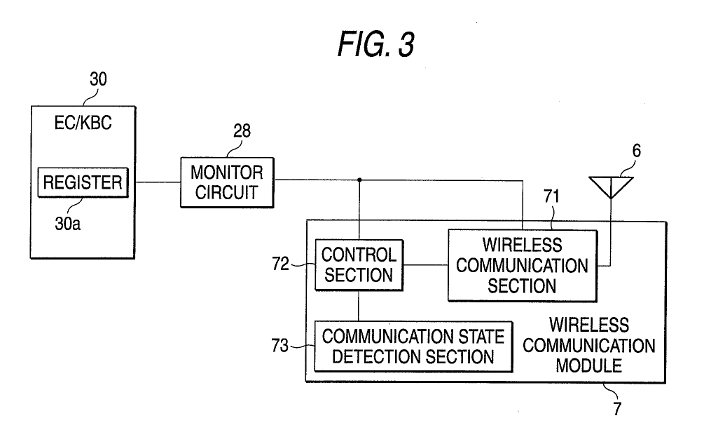

FIG. 2 is a block diagram to show the configuration of the computer according to the embodiment of the invention. FIG. 3 is a block diagram to show the configuration of the wireless communication module according to the embodiment of the invention. The computer 1 is provided with a CPU 20, a north bridge 21, main memory (RAM) 22, a graphics controller 23, video memory (VRAM) 24, a south bridge 25, a hard disk drive (HDD) 26, BIOS-ROM 27, a monitor circuit 28, an embedded controller/keyboard controller IC (EC/KBC) 30, the LCD 5, the first wireless communication module 7a, the second wireless communication module 7b, the third wireless communication module 7c, the touch pad 9, the keyboard 10, and the power switch 11.

The CPU 20 is a processor for controlling the operation of the components of the computer 1. The CPU 20 executes an operating system and various application programs/utility programs loaded into the main memory (RAM) 22 from the HDD 26. The main memory (RAM) 22 is also used to store various data buffers. The CPU 20 also executes a BIOS (Basic Input Output System) stored in the BIOS-ROM 27. The BIOS is a program for hardware control.

The north bridge 21 is a bridge device for connecting a local bus of the CPU 20 and the south bridge 25. The north bridge 21 also has a function of executing communications with the graphics controller 23 through a PCI Express bus, etc. Further, the north bridge 21 also contains a memory controller for controlling the main memory (RAM) 22.

The graphics controller 23 is a display controller for controlling the descriptions and the brightness of the LCD 5 used as a display monitor of the computer 1. The graphics controller 23 sends a video signal corresponding to display data written into the video memory (VRAM) 24 by the OS or the application program to the LCD 5.

The HDD 26, the first wireless communication module 7a, the second wireless communication module 7b, and the third wireless communication module 7c are connected to the south bridge 25. The HDD 26 stores the OS and various application programs.

In the description of the embodiment, the case where a 3G module is used as the first wireless communication module 7a, a WiMAX (Worldwide interoperability for Microwave Access) module is used as the second wireless communication module 7b, and a WLAN (Wireless Local Area Network) module is used as the third wireless communication module 7c is taken as an example. When they need not be distinguished from each other, they are described simply as the wireless communication module 7. The WLAN module is connected to the south bridge 25 through the PCI Express bus and the 3G module and the WiMAX module are connected to the south bridge 25 through a USB bus.

FIG. 3 shows the configuration of the wireless communication module connected to the monitor circuit 28 by taking one of the wireless communication modules 7 as a representative. Each of the wireless communication modules 7 includes a wireless communication section 71, a control section 72, and a communication state detection section 73. The wireless communication section 71 searches for a base station through the antenna 6 according to a command of the control section 72 and sends a connection request signal to the base station. The wireless communication section 71 also receives a response to the connection request signal from the base station and sends the response to the control section 72, thereby establishing wireless communication connection with the base station.

The communication state detection section 73 detects the state of the wireless communication module 7 as to whether or not the wireless communication module 7 is connected, whether or not the wireless communication module 7 searches for a base station, etc., and sends the detected state to the control section 72.

The monitor circuit 28 monitors the power consumption amounts of the first wireless communication module 7a, the second wireless communication module 7b, and the third wireless communication module 7c, and sends notification of the power consumption amounts of the wireless communication modules to the embedded controller/keyboard controller IC (EC/KBC) 30. For example, the monitor circuit 28 can know the power consumption amount of each wireless communication module by monitoring a change in the system power supply of the computer 1 and the voltage among the wireless communication modules.

The EC/KBC 30 is a one-chip microcomputer wherein an embedded controller for power supply management and a keyboard controller for controlling the touch pad, 9, the keyboard 10, etc., are integrated. The EC/KBC 30 executes processing of powering on/off the computer 1 in response to operation of the power switch 11 by the user in conjunction with a power supply circuit 31. The power supply circuit 31 generates the power to be supplied to the components of the computer 1 by using power from the battery 32 incorporated in the computer 1 or external power supplied through the AC adapter 33.

A register 30a is provided in the EC/KBC 30. The power consumption amount of each wireless communication module reported from the monitor circuit 28 is stored in the register 30a. Information of the communication state of each wireless communication module, etc., is also stored in the register 30a. The information stored in the register 30a is read by the BIOS, for example, for control use.

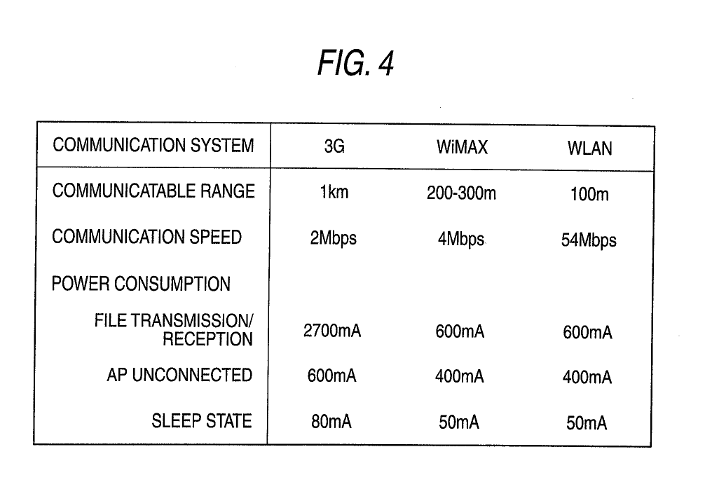

FIG. 4 shows an example of the values of the communication ranges, the communication speeds, and the power consumptions of the 3G module, the WiMAX module, and the WLAN module. 3G (3rd Generation) is a generic name for the third-generation mobile telephone systems; basically CDMA (Code Division Multiple Access) is adopted and high-speed data communications, various services using multimedia, and the like are provided. WiMAX (Worldwide interoperability for Microwave Access) is a standard specification of fixed wireless communications and is provided by changing the use frequency band of IEEE802.16 standard. In the IEEE802.16 standard, change is made to use of 2 GHz to 11 GHz and improvement is made so as to be able to communicate even with a terminal in a vistaless range. WLAN (Wireless LAN) refers to a wireless network made up of machines particularly conforming to IEEE 802.11 specifications and is used mainly to implement a network for communications within a room without using a LAN cable.

Comparing the three types of wireless communication systems of 3G, WiMAX, and WLAN, 3G has a communication range of a 1-km radius and enables a wider range of communications. WiMAX has a communication range of a 20 to 30-m radius and WLAN has a communication range of a 100-m radius; each of the communication ranges is narrower than the communication range of 3G. On the other hand, the communication speed of WLAN is 54 Mbps and high-speed communications can be established as compared with other wireless communication systems. The communication speed of 3G is 2 Mbps and that of WiMAX is 4 Mbps. FIG. 4 also shows an example of the power consumption values of the wireless communication modules at the file transmission/reception time, at the unconnected time, and at the sleep time. The power consumption value at the file transmission/reception time of the 3G module 7a is 2700 mA, a large value as compared with 600 mA (the WiMAX module 7b, the WLAN module 7c). The power consumption when not connected to an access point, of the 3G module 7a is 600 mA, that of the WiMAX module 7b is 400 mA, and that of the WLAN module 7c is 400 mA. The power consumption in a sleep state in which operation of wireless communications, search for an access point, etc., is not performed, of the 3G module 7a is 80 mA, that of the WiMAX module 7b is 50 mA, and that of the WLAN module 7c is 50 mA.

The wireless communications of the 3G module 7a have the advantages that the wireless communication output is large and the communication range is wide; on the other hand, the wireless communications of the 3G module 7a involve large power consumption as compared with the wireless communications of the WiMAX module 7b and the WLAN module 7c. Therefore, to suppress consumption of the battery 32 and prolong the drive time of the computer 1, it is desirable that proper use should be made in such a manner that wireless communications are established with any wireless communication module 7 other than the 3G module 7a as much as possible if the 3G module 7a need not be used.

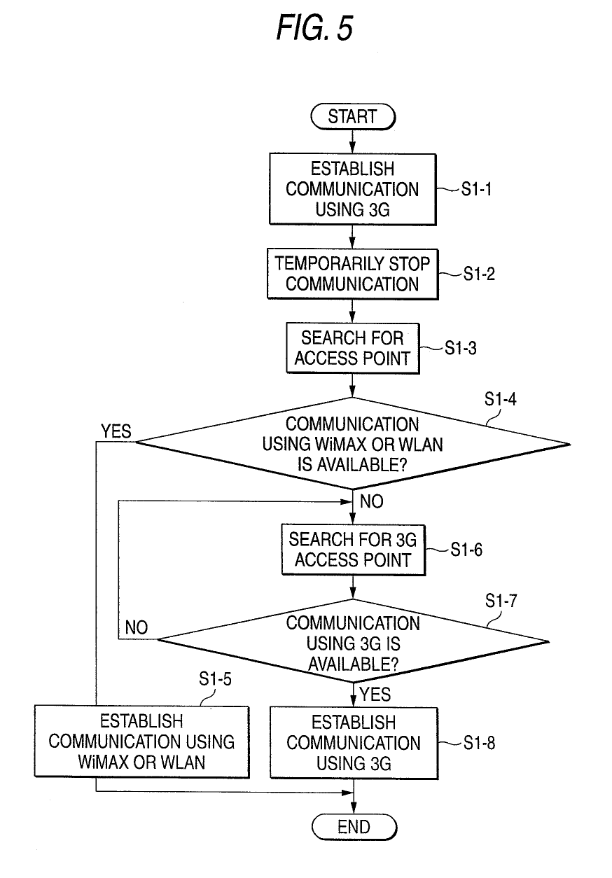

FIG. 5 is a flowchart to show the operation of wireless communication processing according to the embodiment of the invention.

3 G communication enables communications in a wider range as compared with WiMAX and WLAN communications. In the description of the embodiment, it is assumed that wireless communication connection in the 3G module 7a is previously established.

Communications using the 3G module 7a are established in a situation in which the user requires wireless communications (step 1-1). Since wireless communications using the 3G module 7a consume large power as compared with those using the WiMAX module 7b or the WLAN module 7c as described above, it is desirable that any wireless communication module 7 other than the 3G module 7a should be used as much as possible. After wireless communication connection using the 3G module 7a is established and communications are established, the communications using the 3G module 7a are temporarily stopped (step 1-2) and a search is made for any access point other than 3G (step 1-3). At this time, wireless communications may be stopped and a search may be made for an access point at regular time intervals. A search is made for an access point by executing intermittent transmission for wireless communications using WiMAX and WLAN and when an access point is found and wireless communications using WiMAX or WLAN are made possible, the power consumption of the WiMAX module 7b or the WLAN module 7c increases. As the power consumption increases, the OS is informed of the fact through the EC/KBC 30 and the BIOS from the monitor circuit 28 of the computer 1, so that the user can know through the OS that wireless communications using WiMAX or WLAN are made possible.

When it is determined that wireless communications using WiMAX or WLAN are made possible by monitoring the power consumption (YES at step 1-4), wireless communications are established using WiMAX or WLAN (step 1-5). The wireless communications using the 3G module 7a are temporarily stopped and wireless communications are established using WiMAX or WLAN, whereby the power consumption can be reduced as compared with the case where wireless communications are always established using 3G.

When it is impossible to establish wireless communications using WiMAX or WLAN for the reason that an access point is not found although a search is made for an access point or any other reason (NO at step 1-4), a search is made for an access point of 3G having a wider communication range than WiMAX or WLAN (step 1-6). If a 3G access point is not found (NO at step 1-7), the search is repeated and when a 3G access point is found and wireless communications using 3G are made possible (YES at step 1-7), wireless communications are established using 3G (step 1-8).

In a situation in which wireless communication connection is not established using any wireless communication system, it is desirable that first a search should be made for a WiMAX or WLAN access point other than a 3G access point. Since WiMAX or WLAN has the advantage that power consumption of WiMAX or WLAN is smaller than that of 3G although the communication range of WiMAX or WLAN is narrow as compared with 3G, WiMAX or WLAN is effective particularly when the computer 1 is operated with the battery 32.

On the other hand, if the user wants to establish wireless communication connection quickly in a situation in which sufficient power is left in the battery 32, preferentially a search may be made for a 3G access point and wireless communications may be established using 3G.

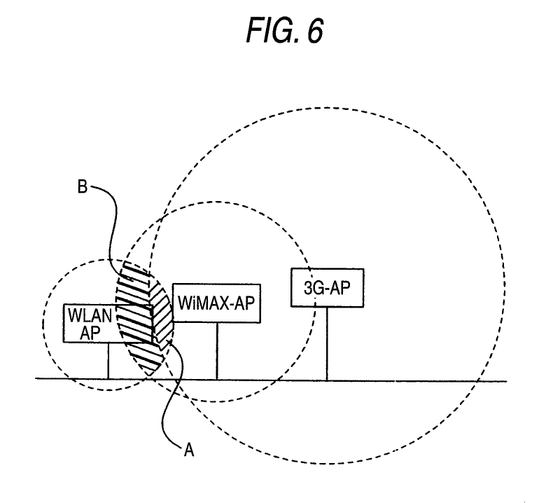

FIG. 6 is a drawing to schematically show the communication ranges of the wireless communication modules according to the embodiment of the invention. Since the communication ranges of the 3G module, the WiMAX module, and the WLAN module are defined as listed in the table of FIG. 4, the available wireless communication system changes with the installation position of an access point and the position where the user possessing the computer 1 exists. As shown in FIG. 6, any of 3G, WiMAX, or WLAN can be used in an area A, and WiMAX or WLAN can be used in an area B. More than one wireless communication system among 3G, WiMAX, and WLAN can be used in the areas A and B, in which case which wireless communication system is assigned a high priority for connection can be determined.

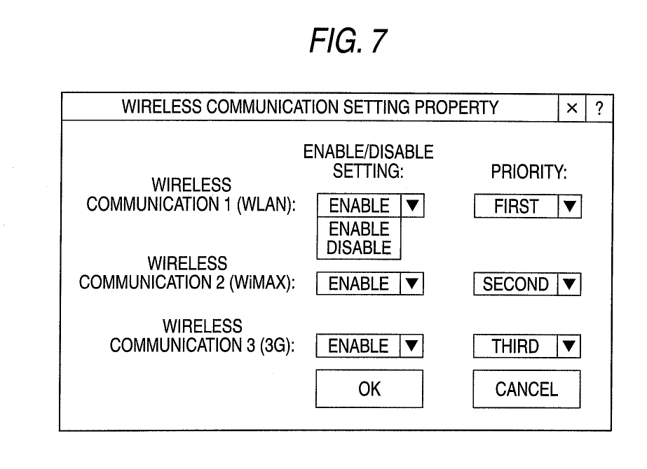

FIG. 7 is a drawing to schematically show a setting screen of the wireless communication modules according to the embodiment of the invention. The user can set the wireless communication system through a utility program used in the OS, for example. The user can set priority of the wireless communication system to be used in such a manner that a first priority is given to WLAN, a second priority is given to WiMAX, and a third priority is given to 3G through a utility program as shown in FIG. 7. In addition to the priority, Enable/Disable of the wireless communication module 7 can also be specified using the utility program, the OS, and the BIOS. If more than one wireless communication system can be used as illustrated in FIG. 6, connection processing is performed in order in response to the setup priority.

Since WLAN has the advantage that the communication speed is higher than that of WiMAX although WLAN has the narrower communication range than WiMAX, it is considered that establishing wireless communications using WLAN contributes to enhancement of the convenience of the user in an environment in which WLAN connection can be established. Thus, if the computer 1 finds a WLAN access point while it finds a WiMAX access point and performs connection processing, connection to WLAN may be made preferentially.

The priority may be set considering power consumption for searching for an access point and power consumption for communications after connection is established in addition to the communication speed and the communication range. That is, a situation is possible in which even a wireless communication system involving small power consumption required for wireless communications after wireless communication connection is established consumes much power as a whole because the wireless communication system consumes much power to search for an access point. In such a case, the sum of power consumption required for searching for an access point and power consumption required for wireless communications in one wireless communication system is compared with that in another wireless communication system and communications can be established using the wireless communication system consuming less power.

As described above, according to the embodiment of the invention, there can be provided an information processing apparatus that can more reduce power consumption in establishing wireless communications.

It is to be understood that the invention is not limited to the above-described specific embodiment thereof and various modifications can be made without departing from the spirit and the scope of the invention.

What is claimed is:

1. An information processing apparatus comprising:
a housing;
an antenna within the housing;
a first wireless communication module within the housing configured to establish wireless communication using a first communication system through the antenna;
a second wireless communication module within the housing configured to establish wireless communication using a second communication system through the antenna, the second communication system having a narrower communication range and smaller power consumption than the first communication system;
a determination unit configured to determine whether or not wireless communication by the first or second wireless communication module is available; and
a controller configured to control the second wireless communication module to establish wireless communication using the second communication system when the determination unit determines that wireless communication by the second wireless communication module is available, regardless of whether or not wireless communication using the first communication system is established by the first wireless communication module.

2. The apparatus of claim 1 further comprising a monitor circuit configured to monitor power consumption of the second wireless communication module, wherein the determination unit is configured to determine availability of wireless communication using the second wireless communication module by an increase in the power consumption of the second wireless communication module.

3. The apparatus of claim 2 further comprising a register in which a power consumption value is set, the power consumption value being used as a reference for determining whether wireless communication by the second wireless communication module is available or not.

4. The apparatus of claim 1, wherein the first wireless communication module is configured to search for a base station to establish wireless communication using the first communication system when the determination unit determines that wireless communication by the second wireless communication module is unavailable.

5. An information processing apparatus comprising:
a housing;
an antenna within the housing;
a first wireless communication module within the housing configured to establish wireless communication using a first communication system through the antenna;
a second wireless communication module within the housing configured to establish wireless communication using a second communication system through the antenna, the second communication system having a narrower communication range and smaller power consumption than the first communication system;
a third wireless communication module within the housing configured to establish wireless communication using a third communication system through the antenna, the third communication system having a narrower communication range and smaller power consumption than the first communication system;
a monitor circuit configured to monitor whether wireless communication by any one of the first through the third wireless communication modules is available; and
a controller configured to control either the second or third wireless communication module to establish wireless communication using either the second or third communication system when the determination unit determines whether wireless communication by either the second or third wireless communication module is available respectively, regardless of whether or not wireless communication using the first communication system is established by the first wireless communication module.

6. The apparatus of claim 5, wherein the monitor circuit comprises a power consumption monitor section configured to determine whether wireless communication by either the second or third wireless communication module is available by an increase in the power consumption of either the second or third wireless communication module respectively.

7. The apparatus of claim 5 further comprising a setting unit configured to set a priority of using either the second or the third wireless communication module for establishing wireless communication when the monitor circuit determines that wireless communications using the second and third wireless communication modules are both available.

8. The apparatus of claim 5 further comprising a search unit configured to search for a base station to establish wireless communication using the first communication system when the monitor circuit determines that wireless communications by the second and the third wireless communication modules are both unavailable.
